(19) United States
(12) Patent Application Publication
(10) Pub. No.: US 2010/0124314 A1
(43) Pub. Date: May 20, 2010

(54) METHOD AND APPARATUS FOR REDUCING DAMAGE TO PHOSPHOR IMAGING PLATES

(76) Inventor: Johan GRAULS, Antwerp (BE)

Correspondence Address: General Electric Company;GE Global Patent Operation, 2 Corporate Drive, Suite 648, Shelton, CT, 06484, US

(21) Appl. No.: 12/271,182

(22) Filed: Nov. 14, 2008

(51) Int. Cl. G21K 4/00; B32B 37/00

(52) U.S. Cl. 378/204; 156/60

(57) ABSTRACT

A method and apparatus for reducing damage to a phosphor imaging plate caused by physical interaction between the phosphor imaging plate and a surface by affixing a protective material to the surface to reduce the physical interaction between the phosphor imaging plate and the surface. Exemplary surfaces include without limitation the surfaces of a computed radiography scanner and a plate protector.

### BACKGROUND OF THE INVENTION

This invention relates generally to phosphor imaging plates used in computer radiography, and more specifically, to reducing damage to phosphor imaging plates.

In Computed Radiography (CR), a reusable phosphor imaging plate is used to capture images by scanning the phosphor imaging plate to read and digitize the image. The phosphor imaging plate, also referred to as a phosphor storage plate, contains a coating of photostimulable storage phosphors. This phosphor coating is protected from damage by a protective top coating. When exposed to X-rays, electrons inside the phosphors are excited and trapped in a semi-stable higher energy state. In order to retrieve the image, the phosphor imaging plate is scanned by a scanning laser beam, which causes the electrons to relax to a lower energy state causing visible light to be emitted. This visible light is captured and converted to a digital bit stream which encodes the digital image, which can be viewed and enhanced using software. When complete, the image on the phosphor imaging plate can be erased by exposing the photostimulable storage phosphors to fluorescent light, after which the phosphor imaging plate can be reused. Absent damage to the phosphor coating, this phosphor imaging plate can be reused several thousands of times.

One source of damage to the phosphor coating is the physical interaction between the CR scanner and the phosphor imaging plate as the plate is fed and transported through the scanner. During scanning, scratches and abrasions to the protective top coating can result as the phosphor imaging plate slides along the surface of the scanner. Another source of damage to the phosphor coating is the physical interaction between a plate protector and the phosphor imaging plate. Given that an image on the phosphor imaging plate can be erased by exposing the photostimulable storage phosphors to fluorescent light, the phosphor imaging plate can be stored and carried in a envelope-like device that covers and shields the side of the phosphor imaging plate having the phosphor coating (i.e., the active side). As the phosphor imaging plate is inserted and removed from the plate protector, scratches and abrasions to the protective top coat can result as the phosphor imaging plate slides along the front surface of the plate protector. Given the frequency of use of the phosphor imaging plate in both a CR scanner and a protector plate, repeated damage to the protective top coating can eventually penetrate and also damage the phosphor coating. When this happens, the phosphor imaging plate must be replaced.

It would therefore be advantageous to have a method and apparatus to reduce damage to phosphor imaging plates during use to prolong the life of the plates.

### BRIEF DESCRIPTION OF THE INVENTION

A method and apparatus for reducing damage to a phosphor imaging plate caused by physical interaction between the phosphor imaging plate and a surface by affixing a protective material to the surface to reduce the physical interaction between the phosphor imaging plate and the surface. Exemplary surfaces include without limitation the surfaces of a computed radiography scanner and a plate protector.

### BRIEF DESCRIPTION OF THE DRAWINGS

FIG. 1 is a top and bottom view of an exemplary phosphor imaging plate.

FIG. 2 is a cross-section of an exemplary phosphor imaging plate.

FIG. 3 is a top view of an exemplary plate protector.

FIG. 4 is a perspective view of an exemplary CR scanner.

FIG. 5 is a top view of an exemplary plate protector with protective material strips in one embodiment of the invention.

FIG. 6 is a perspective view of an exemplary CR scanner with protective material strips in one embodiment of the invention.

### DETAILED DESCRIPTION OF THE INVENTION

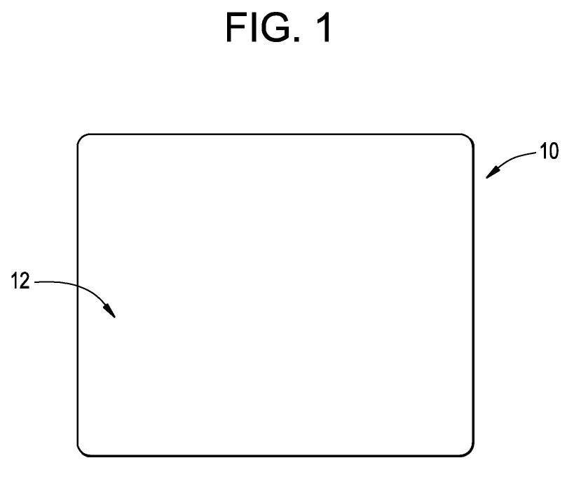

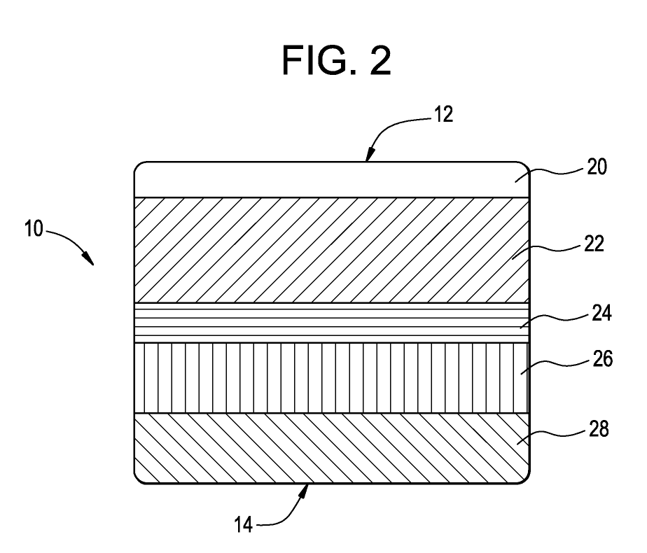

FIG. 1 depicts a top and bottom view of an exemplary phosphor imaging plate 10, having an active side 12 (i.e., the side of the plate having the phosphor coating) and an inactive side (not shown). FIG. 2 is a cross-section of an exemplary phosphor imaging plate 10 illustrating the different layers that typically compose the plate 10. For example, starting from the active side 12, there is top protective coating layer 20, which protects the phosphor coating layer 22, which in turn resides on an adhesion layer 24. The phosphor imaging plate 10 also includes a support layer 26 and base outer coating 28 forming the inactive side 14 of the plate 10. The purpose of the top protective coating layer 20 is to protect the phosphor coating layer 22 to extend the life of the phosphor imaging plate 10.

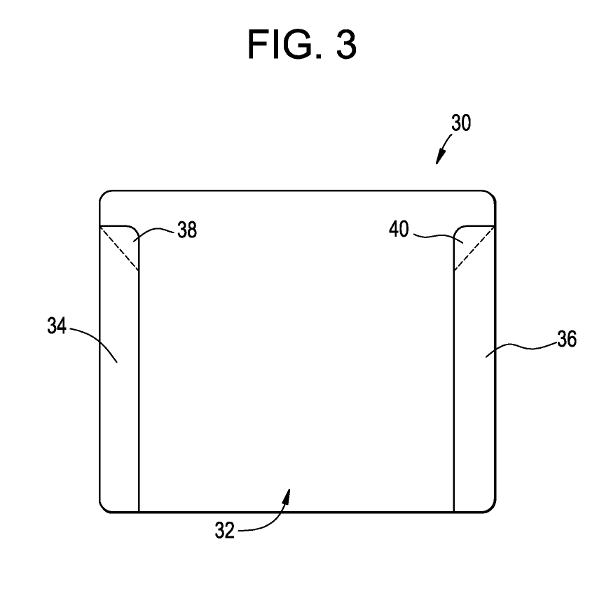

FIG. 3 depicts a top view of an exemplary plate protector 30 having a front surface 32 along with a first guide flap 34 and second guide flap 36 along its sides. The guide flaps 34, 36 allow for a phosphor imaging plate 10 to be inserted and slid into, and subsequently held, by the plate protector 30. To facilitate insertion of the phosphor imaging plate 10, the guide flaps 34, 36 can also include tabs 38, 40 bent upward from the front surface 32 to receive the phosphor imaging pate 10. To protect the phosphor imaging plate 10 from being erased by fluorescent light, the phosphor imaging plate 10 is inserted and slid into the plate protector 30 below the guide flaps 34, 36 with the active side 12 facing and contacting the front surface 32 of the plate protector 30. During insertion and removal of the phosphor imaging plate 10 from the plate protector 30, the active side 12 of the phosphor imaging plate 10 slides along in contact with the front surface 32 of the plate protector 30. This physical interaction between the front surface 32 of the plate protector 30 and the phosphor imaging plate 10 can cause damage to the top protective coating layer 20 and, eventually, the phosphor coating layer 22.

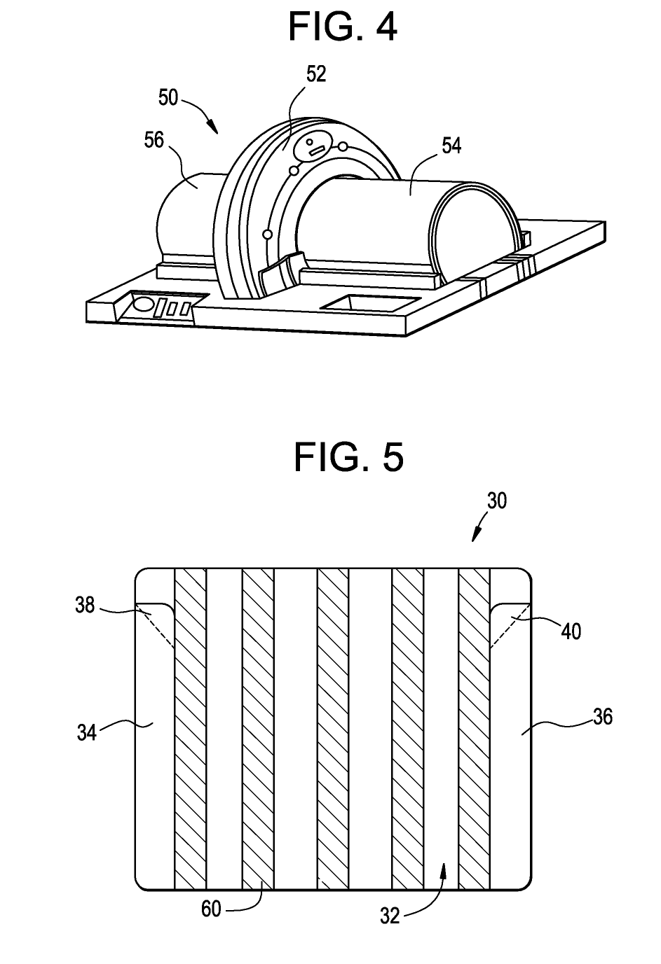

FIG. 4 depicts a perspective view of an exemplary CR scanner 50, which can comprise a scanner section 52 that includes the scanner lasers (not shown) and transport mechanism (e.g., rollers) (not shown) for scanning and transporting the phosphor imaging plate 10 that is fed into the scanner section 52 by curving the plate 10 around and onto the curved inlet drum 54 and is output from the scanner section 52 onto the curved outlet drum 56. In the exemplary CR scanner 50 shown, the phosphor imaging plate 10 is fed into the scanner section 52 with the active side 12 facing the curved inlet drum 54.

In the case where a plate protector 30 is not employed, the active side 12 of the phosphor imaging plate 10 is curved around and placed in contact with the curved inlet drum 54 and then fed into and then transported by the scanner section 52. During transport, the active side 12 of the phosphor imaging plate 10 slides along in contact with the curved inlet drum 54. This physical interaction between the curved inlet drum 54 and the phosphor imaging plate 10 can cause damage to the top protective coating layer 20 and, eventually, the phosphor coating layer 22.

In the case where a plate protector 30 is employed, the back surface of the plate protector 30 is placed on and in contact with the curved inlet drum 54 such that the active side 12 of the phosphor imaging plate 10, which is facing and contacting the front surface 32 of the plate protector 30, is facing the curved inlet drum 54. The plate protector 30 can be fed into the scanner section 52 until the guide flaps 34, 36 come in contact with and are stopped by the scanner section 52. At that point, the phosphor imaging plate 10 is further fed into and then transported by the scanner section. During transport, the active side 12 of the phosphor imaging plate 10 slides along in contact with the front surface 32 of the plate protector 30. This physical interaction between the front surface 32 of the plate protector 30 and the phosphor imaging plate 10 can cause damage to the top protective coating layer 20 and, eventually, the phosphor coating layer 22.

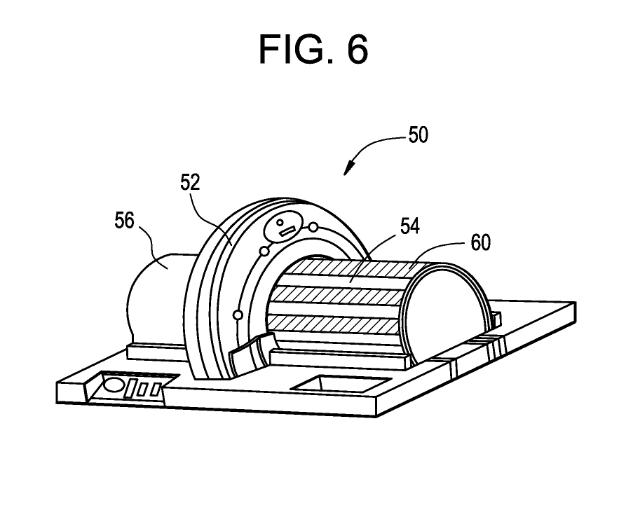

In order to reduce damage to the phosphor imaging plate 10 caused by a physical interaction between a surface and the active side 12 of the phosphor imaging plate 10 as the plate 10 is slid or transported along the surface, in one embodiment of the invention, protective material strips 60 of a relatively soft material (e.g., velvet) or non-stick material (e.g., TEFLON) that will not scratch the plate 10 are affixed to the surface. One example of a suitable velvet material can be provided by Schlegel LS12.00661. For example, FIG. 5 is a top view of an exemplary plate protector 30 in one embodiment of the invention with protective material strips 60 affixed to the front surface 32. Similarly, FIG. 6 is a perspective view of an exemplary CR scanner 50 in one embodiment of the invention with protective material strips 60 affixed to the curved inlet drum 54. The protective material strips 60 can be affixed to the surface using an adhesive agent or other bonding method.

In each of these embodiments, the thickness, width, quantity, and spacing of the protective material strips 60 affixed to the surface are chosen to ensure that active side 12 of the phosphor imaging plate 10 contacts the protective material strips 60, which will not cause any damage, as the phosphor imaging plate 10 is slid or transported along the surface. This reduces the physical interaction between the phosphor imaging plate and the surface. In addition, the protective material strips 60 are oriented in the direction of travel of the phosphor imaging plate 10. Alternatively, the protective material strips 60 could be oriented perpendicularly (or in any other direction with respect) to the direction of travel of the phosphor imaging plate 10. In addition, rather than using protective material strips 60 spaced apart on a surface as shown in FIGS. 5 and 6, the protective material can be used to cover the entire surface for a particular application.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An apparatus for reducing damage to a phosphor imaging plate caused by physical interaction between said phosphor imaging plate and a surface, said apparatus comprising:
said surface; and
protective material affixed to said surface to reduce said physical interaction between said phosphor imaging plate and said surface.

2. The apparatus of claim 1, wherein said surface is part of a computed radiography scanner.

3. The apparatus of claim 2, wherein said part of a computed radiography scanner is a curved inlet drum.

4. The apparatus of claim 1, wherein said surface is part of a plate protector.

5. The apparatus of claim 4, wherein said part of a plate protector is the front surface.

6. The apparatus of claim 1, wherein said protective material is a relatively soft material.

7. The apparatus of claim 6, wherein said protective materials is velvet.

8. The apparatus of claim 1, wherein said protective material is a non-stick material.

9. The apparatus of claim 1, wherein said protective material covers a portion of said surface.

10. The apparatus of claim 9, where in said protective material is affixed to said surface in strips.

11. The apparatus of claim 1, wherein said protective material covers substantially all of said surface.

12. A method for reducing damage to a phosphor imaging plate caused by physical interaction between said phosphor imaging plate and a surface, said method comprising the step of affixing a protective material to said surface to reduce said physical interaction between said phosphor imaging plate and said surface.

13. The method of claim 12, wherein said surface is part of a computed radiography scanner.

14. The method of claim 13, wherein said part of a computed radiography scanner is a curved inlet drum.

15. The method of claim 12, wherein said surface is part of a plate protector.

16. The method of claim 15, wherein said part of a plate protector is the front surface.

17. The method of claim 12, wherein said protective material is a relatively soft material.

18. The method of claim 17, wherein said protective materials is velvet.

19. The method of claim 12, wherein said protective material is a non-stick material.
